(19) United States
(12) Patent Application Publication
(10) Pub. No.: US 2026/0140427 A1
(43) Pub. Date: May 21, 2026

(54) PRIVACY COVER FOR CAMERA, AND CAMERA

(71) Applicant: YEALINK (XIAMEN) NETWORK TECHNOLOGY CO., LTD., Xiamen (CN)

(72) Inventors: Dian WU, Xiamen (CN); Dongping REN, Xiamen (CN)

(21) Appl. No.: 19/388,208

(22) Filed: Nov. 13, 2025

(30) Foreign Application Priority Data
Nov. 15, 2024 (CN) 202411633912.2

(51) Int. Cl. G03B 11/04

(52) U.S. Cl. CPC G03B 11/045

(57) ABSTRACT

Disclosed are a privacy cover for the camera, and a camera. The privacy cover for the camera includes: a housing, where the housing is provided with a photographing hole and an accommodation cavity; a lifting mechanism, where the lifting mechanism is arranged in the accommodation cavity; a first magnetic member, where the one or more first magnetic members are arranged on the lifting mechanism, and located between the lifting mechanism and an inner wall of the housing; and a shielding cover, where an inner wall of the shielding cover is fixedly provided with a second magnetic member attached to the one or more first magnetic members; where the shielding cover is slidably arranged on an outer wall of the housing, and slides along the housing according to lifting of the one or more first magnetic members to shield the photographing hole or avoid the photographing hole.

### CROSS-REFERENCE TO RELATED APPLICATION(S)

The disclosure claims the priority to Chinese Patent Application No. 202411633912.2, filed with the Chinese Patent Office on Nov. 15, 2024 and entitled “Privacy cover for camera, and camera”, which is incorporated in its entirety herein by reference.

### FIELD

Examples of the disclosure relate to, but are not limited to, a privacy cover for a camera, and a camera.

### BACKGROUND

In video conferences, cameras are often used during remote video conferences. In some special conference scenes, to prevent privacy leakage, it is necessary to turn off a photographing function through physical means. Generally, the camera is shielded by an opaque privacy cover for the camera at the front side of the camera.

### SUMMARY

In a first aspect, a privacy cover for the camera, and a camera are provided in examples of the disclosure. The privacy cover for the camera includes: a housing, where the housing is provided with a photographing hole and an accommodation cavity; a lifting mechanism, where the lifting mechanism is arranged in the accommodation cavity; one or more first magnetic members, where the one or more first magnetic members are arranged on the lifting mechanism, and located between the lifting mechanism and an inner wall of the housing, and the lifting mechanism changes positions of the one or more first magnetic members relative to the housing in a height direction; and a shielding cover, where an inner wall of the shielding cover is fixedly provided with a second magnetic member attached to the one or more first magnetic members; where the shielding cover is slidably arranged on an outer wall of the housing, and slides along the housing according to lifting of the one or more first magnetic members to shield the photographing hole or avoid the photographing hole.

In a second aspect, a camera is further provided in the examples of the disclosure. The camera includes a photographing module and any privacy cover for the camera provided by the disclosure, where the photographing module is arranged in an accommodation cavity, and a photographing end of the photographing module is located at a photographing hole.

### BRIEF DESCRIPTION OF DRAWINGS

FIG. 1 shows a perspective view of a privacy cover for a camera and a camera with a housing wall removed according to the disclosure;

FIG. 2 shows a perspective view of a shielding cover according to the disclosure;

FIG. 3 shows a perspective view of an electric motor according to the disclosure;

FIG. 4 shows a perspective view of a privacy cover for a camera and a camera according to the disclosure; and

FIG. 5 shows a schematic diagram of a position of a fourth abrasion-proof sheet according to the disclosure.

### REFERENCE NUMERALS

1. housing; 11. guide post; 12. guide sleeve; 101. photographing hole; 102. accommodation cavity; and 103. guide recess;
2. lifting mechanism; 21. electric motor; 22. bracket; 221. first bracket plate; 222. second bracket plate; 23. rack; and 201. mounting recess;
3. first magnetic member;
4. shielding cover; 41. second magnetic member; 42. cover body; 43. first abrasion-proof sheet; 44. second abrasion-proof sheet; 45. fourth abrasion-proof sheet; and 46. protruding structure;
5. light stop sheet;
6. photographing module; and
7. photoelectric sensor.

### DESCRIPTION OF EMBODIMENTS

Illustrative examples of the disclosure are described below with reference to the accompanying drawings. Various details in the examples of the disclosure are included to facilitate understanding, and should be deemed merely illustrative. Thus, those of ordinary skill in the art should realize that various changes and modifications may be made to the examples described herein without departing from the scope of the disclosure. Similarly, the descriptions of known functions and structures are omitted in the following description for clarity and conciseness.

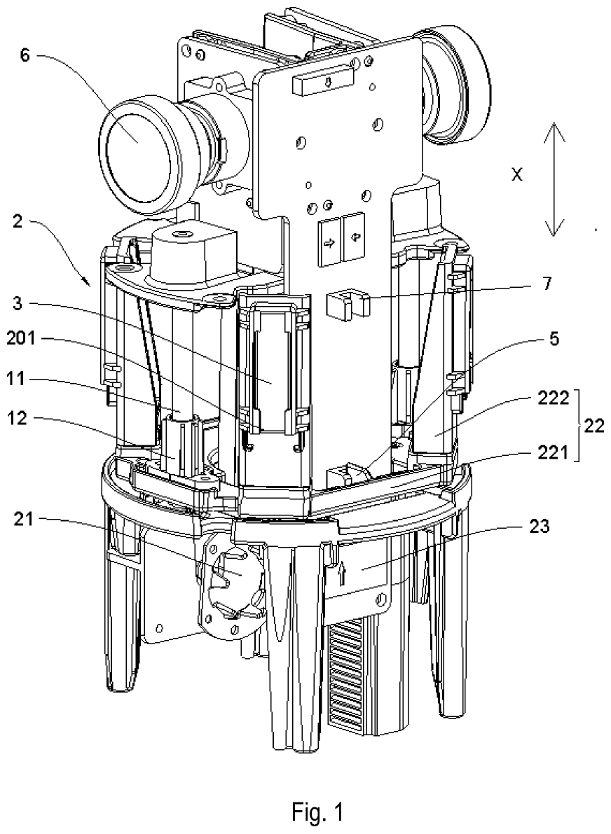

As shown in FIG. 1 to FIG. 4, a privacy cover for the camera is provided in some embodiments of the disclosure. The privacy cover for the camera includes a housing 1, a lifting mechanism 2, a first magnetic member 3, and a shielding cover 4. In some embodiments, one first magnetic member 3 or a plurality of first magnetic members 3 are provided.

The housing 1 is provided with a photographing hole 101 and an accommodation cavity 102. The lifting mechanism 2 is arranged in the accommodation cavity 102. The first magnetic member 3 is arranged on the lifting mechanism 2. The lifting mechanism 2 is configured to drive the first magnetic member 3 to lift in a preset direction X. The first magnetic member 3 is located between the lifting mechanism 2 and an inner wall of the housing 1, and the lifting mechanism 2 may change a height of the first magnetic member 3. An inner wall of the shielding cover 4 is fixedly provided with a second magnetic member 41 attracted to the first magnetic member 3, and the shielding cover 4 is arranged on an outer wall of the housing 1 through attraction between the second magnetic member 41 and the first magnetic member 3 through the housing 1. The shielding cover 4 is slidably arranged on the outer wall of the housing 1, and slides along the housing 1 according to lifting of the first magnetic member 3 to shield the photographing hole 101 or avoid the photographing hole 101.

According to the privacy cover for the camera of the disclosure, the lifting mechanism 2 drives the first magnetic member 3 to move up and down, so that the second magnetic member 41 moves along with the first magnetic member under the attraction of the first magnetic member 3. Further, the shielding cover 4 provided with the second magnetic member 41 moves up and down along with lifting of the first magnetic member 3 to shield the photographing hole 101 or avoid the photographing hole 101. The magnetic-attraction connection enables the shielding cover 4 to have an independent track. The motion of the shielding cover 4 outside the housing 1 is relatively separated from the motion of the lifting mechanism 2 inside the housing 1, and the motion of the magnetic-attraction shielding cover 4 may filter out jamming of motion components of the lifting mechanism 2 to reduce the influence of jamming of fit clearance between a rack 23 and a gear of the lifting mechanism 2 on sliding of the shielding cover 4. Thus, opening and closing of the privacy cover for the camera are smoother.

The shielding cover 4 is independent of the motion components through a magnetic component. Thus, a lifting mechanism may be tested through the cooperation between the lifting mechanism 3 and the shielding cover 4 in a case of being not sleeved with the housing 1, and defective products may be inspected and intercepted in advance at the semi-finished product stage. The shielding cover 4 is driven to lift with the magnetic component as a bridge, so as to be buffered to a particular extent instead of being fixed through screws or hard limitation. Thus, shaking and jamming caused by assembly errors, etc. of a transmission module may be reduced. Since the shielding cover 4 is bound by the magnetic component, so as to be independent, there is no direct connection between the shielding cover 4 and the lifting mechanism 2. Compared with the hard limitation such as screwing and dispensing, the appearance shaping is more convenient, because the appearance without a fixed connection structure has a richer design space. The shielding cover 4 does not need to be fixed to the rack 23, and thus may not be taken as an overall appearance. Accordingly, addition of appropriate unattractiveness coverage treatment to weaken or prevent the influence of the fixed connection structure on the appearance is not required, and the privacy cover for the camera is more attractive, and does not need to be bound with the motion components. The first magnetic member and the second magnetic member are preferably magnets. Compared with other magnetic materials, the magnet features high magnetic strength, good stability, easy machining, etc. Through the high magnetic strength, jamming of the motion components of the lifting mechanism 2 is filtered out. The good stability is conducive to a longer service life of the product. The first magnetic member and the second magnetic member are preferably magnets. Compared with the design that only parts of the first magnetic member and the second magnetic member are magnets, according to the solution that the two magnets are attracted to each other, better alignment may be achieved, and the situation that the privacy cover may not be automatically reset due to dislocation is reduced.

The gear and the rack 23 (the transmission part) of the lifting mechanism 2 may be inspected and tested before assembling a whole machine, so that testing is facilitated. The shielding cover 4 and the transmission part are arranged separately, so that motion inspection may be performed before assembling the housing. Thus, repeated disassembly and assembly of the apparatus during inspection and adjustment are avoided, the production yield is increased, and the maintenance cost is reduced. Since the magnetic field of the magnetic-attraction connection takes a role remotely, the shielding cover 4 does not need additional grooving or an additional fixing structure, and the demand for appearance and attractiveness is satisfied while the structure is simplified and the cost is reduced. The magnetic-attraction connection reduces mechanical jamming caused by conventional hard connection. The magnetic attraction may filter out jamming, making the privacy cover for the camera run more smoothly as a whole. The magnetic-attraction connection allows the shielding cover 4 to have an independent track. Compared with the shielding cover 4 that is hard-connected to the lifting mechanism 2, mechanical jamming may be effectively reduced, and opening and closing of the privacy cover for the camera may be smoother.

In some embodiments, one second magnetic member 41 or a plurality of second magnetic members 41 are provided.

Specifically, the second magnetic members 41 are evenly distributed around the shielding cover 4. Through the magnetic attraction between the second magnetic members 41 and the first magnetic members 3, automatic alignment may be achieved. Thus, after rotated, the privacy cover may still be automatically aligned without affecting using.

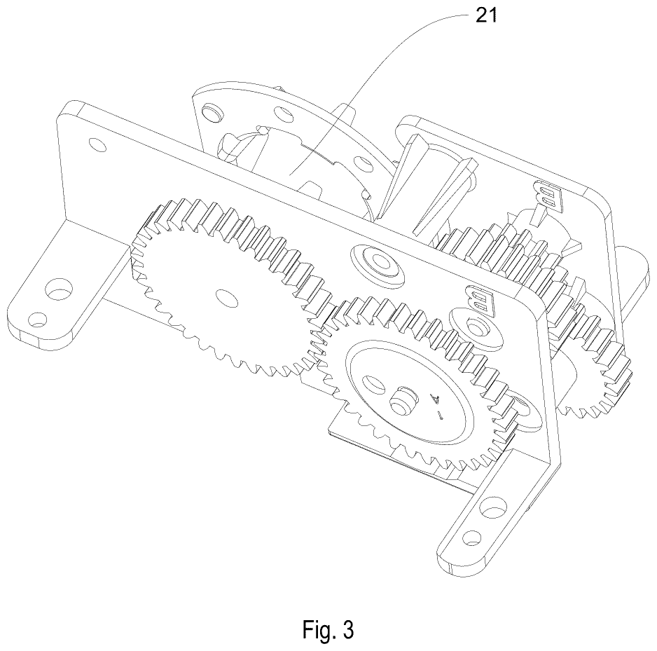

As shown in FIG. 1 and FIG. 3, in some embodiments of the disclosure, the lifting mechanism 2 includes an electric motor 21, a bracket 22, and the rack 23. The electric motor 21 is arranged in the accommodation cavity 102, the rack 23 is arranged on the bracket 22, the rack 23 engages with the electric motor 21, the bracket 22 is slidably arranged on the housing 1, the bracket 22 is provided with a mounting recess 201, and the first magnetic member 3 is arranged on the mounting recess 201.

The electric motor 21 is in engaged connection to the rack 23, so that the lifting mechanism 2 may be raised or lowered. Thus, the stability and accuracy of the lifting mechanism 2 during running are ensured, opening and closing of the magnetic-attraction shielding cover 4 is smoother, and shaking and jamming during motion are reduced. The mounting recess 201 is provided in the bracket 22. Thus, greater flexibility is provided for mounting and dismounting the first magnetic member 3, later maintenance and adjustment are facilitated, and the complexity in the production and maintenance process is reduced. By arranging the electric motor 21 in the accommodation cavity 102, the space is saved on, an entire apparatus is more compact, and the rationality of the structural layout of the product is improved. The lifting mechanism 2 is slidably connected to the housing 1 through the bracket 22 to provide support for a raising or lowering movement process, so that the movement is stabler. The simple combination of the electric motor 21, the rack 23, and the bracket 22 improves the overall reliability of the privacy cover for the camera, ensures that no frequent failures occur in the long-term use of the lifting mechanism 2, simplifies the structural combination, and reduces the manufacturing complexity and the production cost, so that the economic benefits of enterprises may be effectively improved.

Specifically, the electric motor 21 is a stepper motor 21, and the electric motor 21 is provided with a plurality of gears. The plurality of gears engages with one another to adjust a transmission ratio, so that the lifting speed of the lifting mechanism 2 is controlled.

As shown in FIG. 1, in some embodiments of the disclosure, the bracket 22 includes a first bracket plate 221 and a plurality of second bracket plates 222. The plurality of second bracket plates 222 are vertically arranged on the first bracket plate 221, the second bracket plates 222 are slidably connected with the inner wall of the housing 1, the mounting recess 201 is provided on a side surface, closest to the housing 1, of the second bracket plate 222, and the rack 23 is arranged on the first bracket plate 221.

Through the vertical matching combination between the first bracket plate 221 and the second bracket plates 222, the first bracket plate 221 provides stronger structural support for the lifting mechanism 2, and facilitates mounting and protecting of the first magnetic member 3. Thus, the stability and safety of the first magnetic member 3 during opening and closing of the privacy cover are ensured, and the deformation or damage of the first magnetic member 3 due to an external force is effectively reduced. The sliding connection between the second bracket plate 222 and the inner wall of the housing 1 makes lifting of the first magnetic member 3 smoother, reduces the frictional resistance between the lifting mechanism 2 and the housing 1, and improves the lifting efficiency.

By arranging the mounting recess 201 in the side surface, closest to the housing 1, of the second bracket plate 222, flexible mounting of the first magnetic member 3 is facilitated. Moreover, a position of the first magnetic member 3 in the mounting recess 201 may be adjusted according to actual demand. Thus, the height of the first magnetic member 3 is adjusted, of the multiple first magnetic members 3 are aligned in height to generate consistent magnetic forces, and the adaptability of the product is improved. The second bracket plate 222 separates the camera from the electric motor 21 and the rack 23, thereby better protecting an assembly of the internal motor 21 and the rack 23, preventing foreign matter from invading through the photographing hole 101 of the camera, and improving the overall safety and reliability. Through the sliding connection between the second bracket plate 222 and the housing 1, noise and vibration of the lifting mechanism 2 during motion may be effectively reduced, and a quieter use environment may be provided for users. Specifically, the first bracket plate 221 and the second bracket plate 222 are integrally formed.

As shown in FIG. 1, in some embodiments of the disclosure, the first bracket plate 221 is an annular bracket plate, the second bracket plate 222 is an elongated bracket plate, and the rack 23 is arranged on an inner circumferential surface of the first bracket plate 221. The annular first bracket plate 221 provides a uniform support structure. Thus, the lifting mechanism 2 maintains higher stability during lifting, and jamming caused by inclination or imbalance is reduced. By arranging the rack 23 on the inner circumferential surface of the first bracket plate 221, the stress on the first bracket plate 221 is closer to the center of gravity. Thus, a motion mechanism of the second bracket plate 222 may be better matched, the transmission efficiency may be improved, and lifting of the lifting mechanism 2 may be smoother. The combined structure of the annular bracket plate and the elongated bracket plate makes the space utilization more efficient, reduces the space occupied by the rack 23, and allows the first magnetic member 3 to be closer to the inner wall of the housing 1. The annular bracket plate is efficiently wrapped around the internal mechanical assemblies, such as the rack 23 and a circuit board of the photographing module 6, to prevent dust or external objects from invading and improve safety.

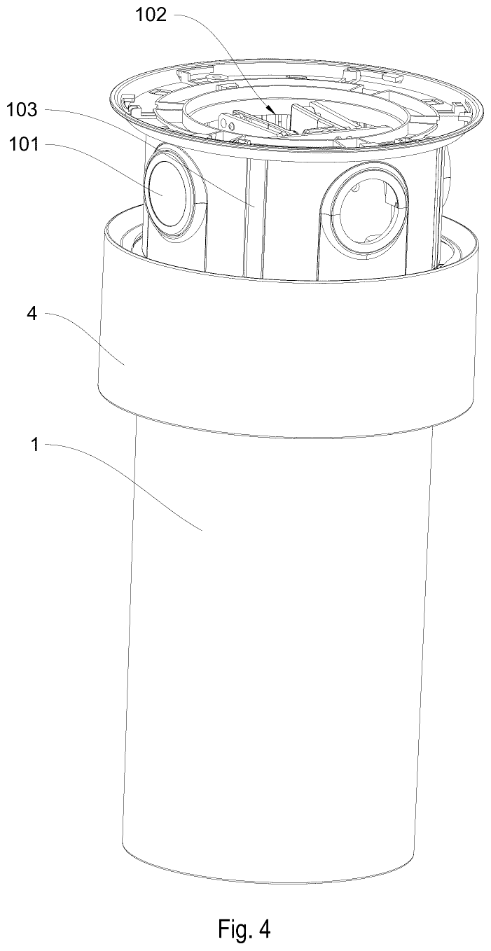

As shown in FIG. 1 and FIG. 4, in some embodiments of the disclosure, the housing 1 is provided with a guide post 11 and a guide sleeve 12 arranged on the guide post 11. The guide post 11 is arranged in the accommodation cavity 101, the guide sleeve 12 is connected to the second bracket plate 222, and the second bracket plate 222 slides along the guide post 11 through the guide sleeve 12. In some embodiments, one guide sleeve 12 or a plurality of guide sleeves 12 are provided, and one guide post 11 or a plurality of guide posts 11 are provided.

Due to the cooperation between the guide post 11 and the guide sleeve 12, the second bracket plate 222 may slide smoothly along the guide post 11. Thus, the friction generated during motion is reduced, the lifting mechanism 2 moves more smoothly, and the smoothness of opening and closing of the privacy cover is improved. The guide post 11 provides a clear motion track. Thus, the second bracket plate 222 is accurately located during lifting, deviation or jamming is avoided, and the reliability of use is improved. The guide post 11 provides stable support for the second bracket plate 222, and the guide sleeve 12 provides stable connection for the second bracket plate 222. Thus, the second bracket plate maintains the vertical and horizontal stability during motion, and the risk of failure due to structural instability is reduced. Through the desirable cooperation between the guide sleeve 12 and the guide post 11, direct contact between the motion components may be effectively reduced, the abrasion may be reduced, and the service life of the privacy cover may be prolonged. The smoothness and stability of a mechanism sliding along the guide post 11 improve the lifting smoothness of the lifting mechanism 2, so that opening and closing of the privacy cover is easier and more comfortable. The connection between the guide sleeve 12 and the second bracket plate 222 effectively avoids the risk of accidental loosening or falling off, improves the safety of the lifting mechanism 2, and ensures the reliability during use.

As shown in FIG. 1, in some embodiments of the disclosure, the privacy cover for the camera further includes a photoelectric sensor 7. The photoelectric sensor is arranged on the housing 1, and configured to monitor the height of the bracket 22. By arranging the photoelectric sensor 7 on the housing 1, in the first position shielding the photographing hole 101 and the second position avoiding the photographing hole 101, a corresponding position of the photoelectric sensor 7 on the bracket 22 is provided with a light stop sheet 5. Thus, the photoelectric sensor 7 monitors the height of the bracket 22 to control the bracket 22 to stop or start. Compared with a baffle type limiting shielding cover 4, monitoring by the photoelectric sensor 7 may realize the silent stop of the motion of the bracket 22, so that the demand during the conference may be satisfied. In some embodiments, one light stop sheet 5 or a plurality of light stop sheets 5 are provided.

In some embodiments of the disclosure, the housing 1 is provided with a guide recess 103. The guide recess 103 is located in the outer wall of the housing 1. The shielding cover 4 is arranged on the guide recess, and slides along the guide recess 103 to shield the photographing hole 101 or avoid the photographing hole 101.

Through the simple sliding operation, the shielding cover 4 may be moved from the first position shielding the photographing hole 101 to the second position avoiding the photographing hole 101, so that the operation is intuitive, and the use is convenient. When in the first position, the shielding cover 4 may completely shield the photographing hole 101, so that the user privacy may be effectively protected, and unauthorized photographing may be prevented. By providing the vertical guide recess 103, the shielding cover 4 may slide randomly. Moreover, the shielding cover 4 is provided with a protruding structure 46 that is clamped into the guide recess 103 to prevent the shielding cover 4 from rotating. Thus, the shielding cover 4 may be rapidly switched to the second position when the camera is in use, and automatically returned to the first position when the camera is not in use. The guide recess 103 provides stable guidance, so that the shielding cover 4 is unlikely to fall off or get stuck during sliding, and the safety and reliability during use are ensured. The guide recess 103 may reduce the friction between the shielding cover 4 and the housing 1. Thus, the abrasion is reduced, the durability of the product is improved, and the service life is prolonged. Through the easy-to-slide design, users may get the smoother experience in a case of switching to a privacy state, and the overall satisfaction of the product may be improved.

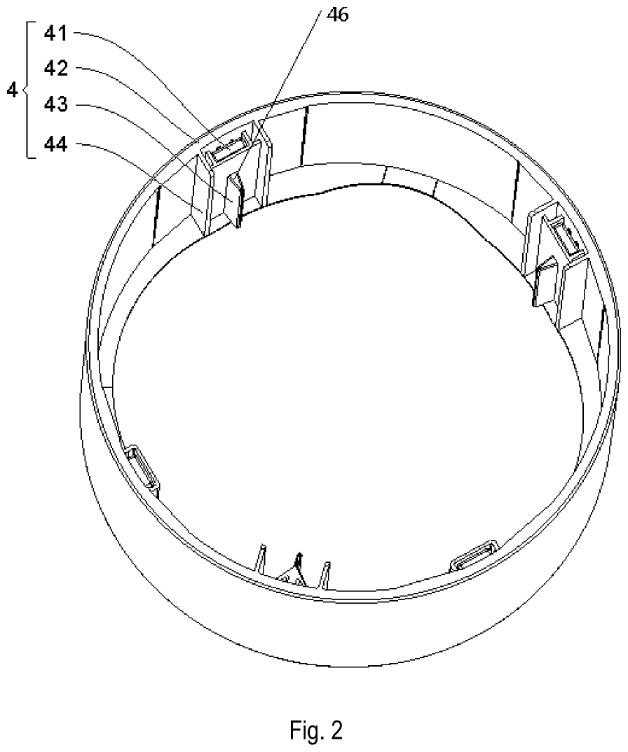

As shown in FIG. 2 and FIG. 4, in some embodiments of the disclosure, the shielding cover 4 further includes a cover body 42 and a first abrasion-proof sheet 43. The cover body 42 sleeves the outer wall of the housing 1, the first abrasion-proof sheet 43 is arranged on the cover body 42, and abuts against the outer wall of the housing 1, and the second magnetic member 41 is arranged between the first abrasion-proof sheet 43 and the cover body 42.

By providing the first abrasion-proof sheet 43 on the cover body 42, the friction between the cover body 42 and the outer wall of the housing 1 is effectively reduced, the abrasion caused by frequent sliding during use is reduced, and the service life of the product is prolonged. The first abrasion-proof sheet 43 takes a role of protection, and also effectively prevents dust and dirt from entering the second magnetic member 41. Thus, cleanliness of the second magnetic member 41 and normal movement of the shielding cover 4 are ensured, and the overall performance is improved. By sandwiching the second magnetic member 41 between the first abrasion-proof sheet 43 and the cover body 42, additional stability is provided to ensure that the second magnetic member 41 is unlikely to be loosened or fall off during use, and thus the reliability of the product is improved. Through the first abrasion-proof sheet 43, the sliding operation of the shielding cover 4 is smoother, the user experience is enhanced, and discomfort caused by the friction is reduced. The cover body 42, the first abrasion-proof sheet 43, and the magnetic components cooperate with one another, so that the overall structure is more compact and rational, the production cost is reduced, and the competitiveness of the product is improved. Specifically, the first abrasion-proof sheet 43 is detachably arranged on the cover body 42. Through the detachable first abrasion-proof sheet 43, cleanliness and maintenance are simpler and more convenient, the user may easily disassemble and replace the abrasion-proof sheet, the maintenance cost is reduced, and the maintenance time is shortened.

As shown in FIG. 2 and FIG. 4, in some embodiments of the disclosure, the shielding cover 4 further includes second abrasion-proof sheets 44. The second abrasion-proof sheets 44 are arranged on the cover body 42, abut against the outer wall of the housing 1, and are located at two sides of the first abrasion-proof sheet 43. By adding the second abrasion-proof sheets 44, the protection on the second magnetic member 41 is enhanced, and a multi-layer abrasion-proof design is formed to effectively reduce the abrasion and scratches caused by daily use, so that the service life of the product is prolonged. The second abrasion-proof sheet 44 abuts against the outer wall of the housing 1, so that the pressure applied to the cover body 42 during opening and closing may be evenly distributed, the risk of local abrasion may be reduced, and the structural stability may be improved. During use, the second abrasion-proof sheet 44 may reduce the collision sound between the cover body 42 and the housing 1, reduce the noise, provide a quieter use environment, and improve the user experience. In some embodiments, one second abrasion-proof sheet 44 or a plurality of second abrasion-proof sheets 44 are provided.

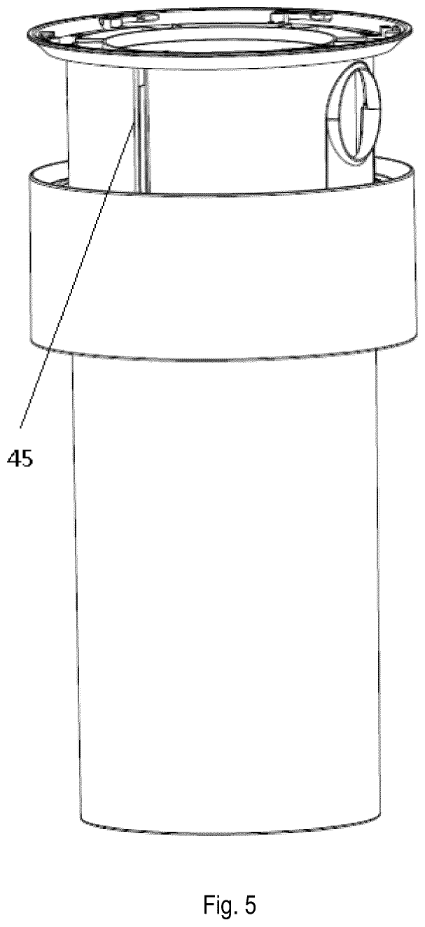

In addition to the above first abrasion-proof sheet 43 and second abrasion-proof sheets 44, a third abrasion-proof sheet may be added to a bottom of the guide recess 103, and fourth abrasion-proof sheets 45 may be added to a left side and a right side of the guide recess 103 (as shown in FIG. 5) according to the actual situation. All the above abrasion-proof sheets may be randomly matched for use without limitation.

The multiple abrasion-proof treatment may enable the users to feel more at ease during use, better reduce the movement noise of the shielding cover 4, and enhance the credibility of the product and user satisfaction. Specifically, the independent and detachable arrangement of the second abrasion-proof sheets 44 makes it easy to replace. Thus, the user may easily replace the abraded abrasion-proof sheet during maintenance, and the difficulty and cost of maintenance may be reduced.

As shown in FIG. 1 and FIG. 4, in a second aspect of the disclosure, a camera is provided in some embodiments. The camera includes a photographing module 6 and the above privacy cover for the camera, where the photographing module 6 is arranged in an accommodation cavity 102, and a photographing end of the photographing module 6 is located at a photographing hole 101.

It should be understood that various forms of flows shown above may be used, with steps re-ranked, added, or deleted. For example, various steps described in the disclosure may be executed in parallel, in sequence, or in different orders, as long as the desired results of the technical solutions disclosed in the disclosure may be achieved, which will not be limited herein.

The above particular embodiments are not intended to limit the scope of protection of the disclosure. Those skilled in the art should understand that various modifications, combinations, sub-combinations, and substitutions may be made according to the design requirements, etc. Any modifications, equivalent replacements, improvements, etc. made within the principles of the disclosure should fall within the scope of protection of the disclosure.

What is claimed is:

1. A privacy cover for a camera, comprising:
a housing, wherein the housing is provided with a photographing hole and an accommodation cavity;
a lifting mechanism, wherein the lifting mechanism is arranged in the accommodation cavity;
one or more first magnetic members, wherein the one or more first magnetic members are arranged on the lifting mechanism, and located between the lifting mechanism and an inner wall of the housing; and
a shielding cover, wherein the shielding cover is provided with a second magnetic member attached to the one or more first magnetic members; wherein
the lifting mechanism is configured to drive each of the one or more first magnetic members to lift in a preset direction, and drive the shielding cover to slide along the housing through magnetic attraction between the one or more first magnetic members and the second magnetic member, so as to enable the shielding cover to have:
a first position shielding the photographing hole, and
a second position avoiding the photographing hole.

2. The privacy cover for the camera according to claim 1, wherein the lifting mechanism comprises:
an electric motor, wherein the electric motor is arranged in the accommodation cavity;
a bracket, wherein the bracket is slidably arranged on the housing, the bracket is provided with a mounting recess, and the one or more first magnetic members are arranged in the mounting recess; and
a rack, wherein the rack is arranged on the bracket, and the rack engages with the electric motor.

3. The privacy cover for the camera according to claim 2, wherein the bracket comprises:
one or more first bracket plates; and
one or more second bracket plates, wherein each of the one or more second bracket plates is vertically arranged on each of the one or more first bracket plates, and slidably connected to the inner wall of the housing; and
the mounting recess is provided in a side surface, closest to the housing, of the one or more second bracket plates, and the rack is arranged on the one or more first bracket plates.

4. The privacy cover for the camera according to claim 3, wherein each of the one or more first bracket plates is an annular bracket plate, each of the one or more second bracket plates is an elongated bracket plate, and the rack is arranged on an inner circumferential surface of the one or more first bracket plates.

5. The privacy cover for the camera according to claim 3, wherein the accommodation cavity of the housing is further internally provided with:
one or more guide posts; and
one or more guide sleeves, wherein each of the one or more guide sleeves is arranged on each of the one or more guide posts, and connected to each of the one or more second bracket plates, and the one or more second bracket plates slide along the one or more guide posts through the one or more guide sleeves.

6. The privacy cover for the camera according to claim 2, wherein the privacy cover for the camera further comprises a photoelectric sensor, wherein the photoelectric sensor is arranged on the housing, and configured to monitor a height of the bracket.

7. The privacy cover for the camera according to claim 1, wherein an outer wall of the housing is provided with a guide recess, the shielding cover is arranged on the guide recess, and magnetic attraction between the one or more first magnetic members and the second magnetic member drives the shielding cover to slide along the guide recess, to enable the shielding cover to be provided with:
the first position shielding the photographing hole, and
the second position avoiding the photographing hole.

8. The privacy cover for the camera according to claim 1, wherein the shielding cover further comprises:
a cover body, wherein the cover body sleeves an outer wall of the housing; and
a first abrasion-proof sheet, wherein the first abrasion-proof sheet is arranged the cover body, and abuts against the outer wall of the housing, and the second magnetic member is arranged between the first abrasion-proof sheet and the cover body.

9. The privacy cover for the camera according to claim 1, wherein the one or more first magnetic members and the second magnetic member are made of magnetic materials.

10. The privacy cover for the camera according to claim 1, wherein second magnetic members are provide and evenly arranged around the shielding cover.

11. The privacy cover for the camera according to claim 2, wherein the electric motor is a stepper motor, and the electric motor is provided with a plurality of gears, and the plurality of gears engage with one another to adjust a transmission ratio.

12. The privacy cover for the camera according to claim 2, wherein there are a plurality of mounting recesses, positions of the one or more first magnetic members in the plurality of mounting recesses are adjustably arranged to adjust lifting heights of the one or more first magnetic members in the preset direction, so as to align a plurality of first magnetic members of the one or more first magnetic members with one another in height to generate consistent magnetic forces.

13. The privacy cover for the camera according to claim 2, wherein each of the one or more second bracket plates separates the camera from the electric motor and the rack.

14. The privacy cover for the camera according to claim 3, wherein the one or more first bracket plates and the one or more second bracket plates are integrally formed.

15. The privacy cover for the camera according to claim 3, wherein the lifting mechanism further comprises:
one or more light stop sheets, wherein the one or more light stop sheets are arranged on the bracket, and configured to control the bracket to start or stop.

16. The privacy cover for the camera according to claim 7, wherein the shielding cover is provided with a protruding structure, and the protruding structure is clamped into the guide recess to prevent the shielding cover from rotating; and
the shielding cover moves from the first position shielding the photographing hole to the second position avoiding the photographing hole, and the shielding cover completely shields the photographing hole when in the first position.

17. The privacy cover for the camera according to claim 8, wherein the first abrasion-proof sheet is detachably arranged on the cover body.

18. The privacy cover for the camera according to claim 8, wherein the shielding cover further comprises:
one or more second abrasion-proof sheets, wherein the one or more second abrasion-proof sheets are arranged on the cover body and located at two sides of the first abrasion-proof sheet, and abut against the outer wall of the housing.

19. The privacy cover for the camera according to claim 7, wherein the privacy cover for the camera further comprises:
one or more fourth abrasion-proof sheets, wherein the one or more fourth abrasion-proof sheets are arranged at two sides of the guide recess.

20. A camera, comprising a photographing module and the privacy cover for the camera according to claim 1, wherein the photographing module is arranged in an accommodation cavity, and a photographing end of the photographing module is located at a photographing hole.
